(19) United States
(12) Patent Application Publication
(10) Pub. No.: US 2012/0166659 A1
(43) Pub. Date: Jun. 28, 2012

(54) Node and Method for Quality of Service (QoS) Control

(75) Inventors: Johan Hjelm, Tokyo (JP); Toshikane Oda, Tokyo (JP)

(73) Assignee: TELEFONAKTIEBOLAGET L M ERICSSON (PUBL), Stockholm (SE)

(21) Appl. No.: 13/394,364

(22) PCT Filed: Sep. 16, 2009
(86) PCT No.: PCT/JP2009/066711

§ 371 Date: Mar. 6, 2012

(51) Int. Cl. G06F 15/16

(52) U.S. Cl. 709/228

(57) ABSTRACT

The present invention generally relates to a node and method for quality of service (QoS) control. The present invention particularly relates, but is not limited to, a technology that enables QoS control for a communication that is based on a protocol such as the Hypertext Transfer Protocol (HTTP), which does not mandate the use of a session description protocol (SDP) message.

### TECHNICAL FIELD

The present invention generally relates to a node and method for quality of service (QoS) control. The present invention particularly relates, but is not limited to, a technology that enables QoS control for a communication that is based on a protocol such as the Hypertext Transfer Protocol (HTTP), which does not mandate the use of a session description protocol (SDP) message.

### BACKGROUND

Currently, services such as voice over IP (VoIP) communication services and video streaming services are widespread. Because such services are delay-sensitive, it is important to provide adequate quality of service (QoS).

WO 2007/045278 proposes a mechanism to ensure quality of service interoperability between two or more networks. According to WO 2007/045278, a media type described in an SDP message is mapped to a UPnP TrafficClass value, which corresponds to priority of communication traffic in a Universal Plug and Play (UPnP) network.

However, because WO 2007/045278 relies on an SDP message, it is not possible to provide QoS for a communication that is based on a protocol such as HTTP, which does not mandate the use of an SDP message.

Meanwhile, when a communication traverses two or more networks as described in WO 2007/045278, if priority for the communication set in one network is not consistent with priority for the communication set in another network, communication resource is likely wasted. For example, assume the case that high priority is set in a first network and low priority is set in a second network connected to the first network. In this case, the communication traffic will go through the first network with little delay, but it may be delayed in the second network. As a result, the communication resource of the first network, which is reserved in order to give high priority to the communication, will be wasted.

However, there is no conventional art that enables consistent QoS control in a plurality of networks.

### SUMMARY

The present invention is intended to address the above-described problem, and it is a feature thereof to introduce a technology that enables QoS control for a communication that is based on a protocol such as HTTP, which does not mandate the use of an SDP message.

Another feature of the present invention is to enable consistent QoS control in a plurality of networks.

According to the first aspect of the present invention, there is provided a control node for use in an environment where a network includes a decision node for deciding a quality of service (QoS) parameter, and a first communication device and a second communication device are connected to the network, comprising:

a request receiving unit for receiving a QoS request for providing QoS for a communication session between the first communication device and the second communication device, the QoS request including session-related information from which QoS required for the communication session is derived;

a requesting unit for requesting the decision node to decide a QoS parameter for enforcing QoS for the communication session based on the session-related information;

a parameter receiving unit for receiving a QoS parameter for the network decided by the decision node, for enforcing QoS for the communication session in the network; and

a sending unit for sending a result of the decision of the QoS parameter for the network to the second communication device.

According to the second aspect of the present invention, there is provided a control node for use in an environment where a first network is connected to a second network via a gateway node, the first network includes a first communication device, the second network includes a decision node for deciding a quality of service (QoS) parameter, and a second communication device is connected to the second network, comprising:

a request receiving unit for receiving a QoS request for providing QoS for a communication session between the first communication device and the second communication device, the QoS request including session-related information from which QoS required for the communication session is derived;

a requesting unit for requesting the decision node to decide a QoS parameter for enforcing QoS for the communication session based on the session-related information;

a parameter receiving unit for receiving a QoS parameter for the second network decided by the decision node, for enforcing QoS for the communication session in the second network; and

a sending unit for sending a result of the decision of the QoS parameter for the second network to the second communication device.

According to the third aspect of the present invention, there is provided a decision node for deciding a quality of service (QoS) parameter in an environment where a first network is connected to a second network via a gateway node, the first network includes a first communication device and a first QoS enforcement node for enforcing QoS in the first network, the second network includes a second QoS enforcement node for enforcing QoS in the second network, and a second communication device is connected to the second network, comprising:

a receiving unit for receiving a request for deciding a QoS parameter for a communication session between the first communication device and the second communication device, the request including session-related information from which QoS required for the communication session is derived;

an obtaining unit for obtaining, from a control node which communicates with the gateway node, first network-related information from which highest QoS enforceable for the communication session in the first network is derived, and for obtaining, from the second QoS enforcement node, second network-related information from which highest QoS enforceable for the communication session in the second network is derived;

a deciding unit for deciding a first QoS parameter for enforcing QoS for the communication session in the first network and a second QoS parameter for enforcing QoS for the communication session in the second network based on the session-related information, the first network-related information, and the second network-related information; and

a sending unit for sending the first QoS parameter to the first QoS enforcement node, and for sending the second QoS parameter to the second QoS enforcement node.

According to the fourth aspect of the present invention, there is provided a method for controlling a control node for use in an environment where a network includes a decision node for deciding a quality of service (QoS) parameter, and a first communication device and a second communication device are connected to the network, comprising:

a request receiving step of receiving a QoS request for providing QoS for a communication session between the first communication device and the second communication device, the QoS request including session-related information from which QoS required for the communication session is derived;

a requesting step of requesting the decision node to decide a QoS parameter for enforcing QoS for the communication session based on the session-related information;

a parameter receiving step of receiving a QoS parameter for the network decided by the decision node, for enforcing QoS for the communication session in the network; and

a sending step of sending the QoS parameter for the network to the second communication device.

According to the fifth aspect of the present invention, there is provided a method for controlling a control node for use in an environment where a first network is connected to a second network via a gateway node, the first network includes a first communication device, the second network includes a decision node for deciding a quality of service (QoS) parameter, and a second communication device is connected to the second network, comprising:

a request receiving step of receiving a QoS request for providing QoS for a communication session between the first communication device and the second communication device, the QoS request including session-related information from which QoS required for the communication session is derived;

a requesting step of requesting the decision node to decide a QoS parameter for enforcing QoS for the communication session based on the session-related information;

a parameter receiving step of receiving a QoS parameter for the second network decided by the decision node, for enforcing QoS for the communication session in the second network; and

a sending step of sending the QoS parameter for the second network to the second communication device.

According to the sixth aspect of the present invention, there is provided a method for controlling a decision node for deciding a quality of service (QoS) parameter in an environment where a first network is connected to a second network via a gateway node, the first network includes a first communication device and a first QoS enforcement node for enforcing QoS in the first network, the second network includes a second QoS enforcement node for enforcing QoS in the second network, and a second communication device is connected to the second network, comprising:

a receiving step of receiving a request for deciding a QoS parameter for a communication session between the first communication device and the second communication device, the request including session-related information from which QoS required for the communication session is derived;

an obtaining step of obtaining, from a control node which communicates with the gateway node, first network-related information from which highest QoS enforceable for the communication session in the first network is derived, and for obtaining, from the second QoS enforcement node, second network-related information from which highest QoS enforceable for the communication session in the second network is derived;

a deciding step of deciding a first QoS parameter for enforcing QoS for the communication session in the first network and a second QoS parameter for enforcing QoS for the communication session in the second network based on the session-related information, the first network-related information, and the second network-related information; and

a sending step of sending the first QoS parameter to the first QoS enforcement node, and for sending the second QoS parameter to the second QoS enforcement node.

The main advantage of the present invention is that QoS control is enabled for a communication that is based on a protocol such as HTTP, which does not mandate the use of an SDP message.

Further features of the present invention will become apparent from the following description of exemplary embodiments with reference to the attached drawings, in which like reference characters designate the same or similar parts throughout the figures thereof.

### BRIEF DESCRIPTION OF DRAWINGS

FIG. 1 illustrates an overview of a communication system 100 according to the first embodiment;

FIG. 2 is a functional block diagram of an application server (AS) 111 according to the first and second embodiments;

FIG. 3 is a sequence diagram illustrating a procedure for providing QoS for a communication session between a user equipment (UE) 120 and a service providing server (SPS) 130 according to the first embodiment;

FIG. 4 is a sequence diagram illustrating a procedure for providing QoS for a communication session between the UE 120 and the SPS 130 according to an alternative scenario of the first embodiment;

FIG. 5 illustrates an overview of a communication system 500 according to the second embodiment;

FIG. 6 is a functional block diagram of a policy decision function (PDF) 530 according to the second embodiment;

FIG. 7 is a sequence diagram illustrating a procedure for providing QoS for a communication session between the UE 120 and the SPS 130 according to the second embodiment; and

FIG. 8 is a sequence diagram illustrating a procedure for providing QoS for a communication session between the UE 120 and the SPS 130 according to an alternative scenario of the second embodiment.

### DETAILED DESCRIPTION

Embodiments of the present invention will now be described with reference to the attached drawings. Each embodiment described below will be helpful in understanding a variety of concepts from the generic to the more specific.

It should be noted that the technical scope of the present invention is defined by the claims, and is not limited by each embodiment described below. In addition, not all combinations of the features described in the embodiments are always indispensable for the present invention.

### First Embodiment

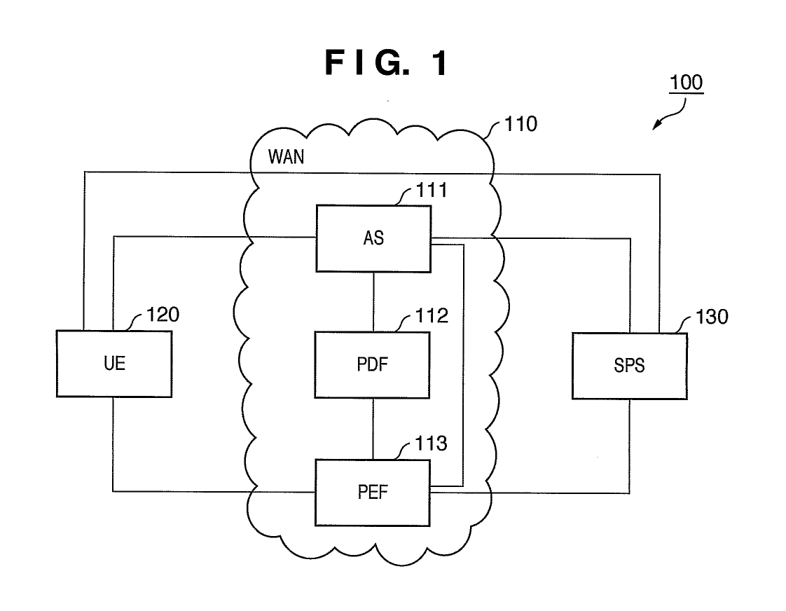

FIG. 1 illustrates an overview of a communication system 100 according to the first embodiment. The communication system 100 includes a wide area network (WAN) 110, which may be, for example, the Internet. A user equipment (UE) 120, which acts as a first communication device, and a service providing server (SPS) 130, which acts as a second communication device, are connected to the WAN 110. The UE 120 and the SPS 130 may communicate with each other via the WAN 110.

The WAN 110 includes an application server (AS) 111, a policy decision function (PDF) 112, and a policy enforcement function (PEF) 113. The AS 111 is configured to periodically obtain device-related information of the UE 120, which represents, for example, capability and presence status of the UE 120. In some scenarios, the AS 111 is also configured to act as a proxy server that mediates the communication between the UE 120 and the SPS 130.

The PDF 112 is a functional entity that determines and authorizes policies, including a QoS policy, for a user. The PDF 112 is configured to decide QoS parameters for enforcing the QoS policy. The PDF 112 may be Policy and Charging Rule Function (PCRF) as defined in 3GPP Policy and Charging Control Architecture (PCC) (3GPP TS 23.203), Resource and Admission Control Subsystem (RACS) as defined in ETSI TISPAN (ETSI ES 282 003), or Policy Decision Point (PDP) as defined in IETF (IETF 2753).

The PEF 113 is a functional entity that enforces the QoS policy, based on the QoS parameters decided by the PDF 112. The PEF 113 may also enforce the other policies determined by the PDF 112. To be exact, the PEF 113 is implemented in respective nodes (such as access routers) that are located in the data transmission path between the UE 120 and the SPS 130, but such nodes are not shown in FIG. 1 for the sake of simplicity.

It should be noted that although the specific terms such as SPS are used in the description, the present invention is not limited thereto. For example, a cellular phone may be employed instead of the SPS 130.

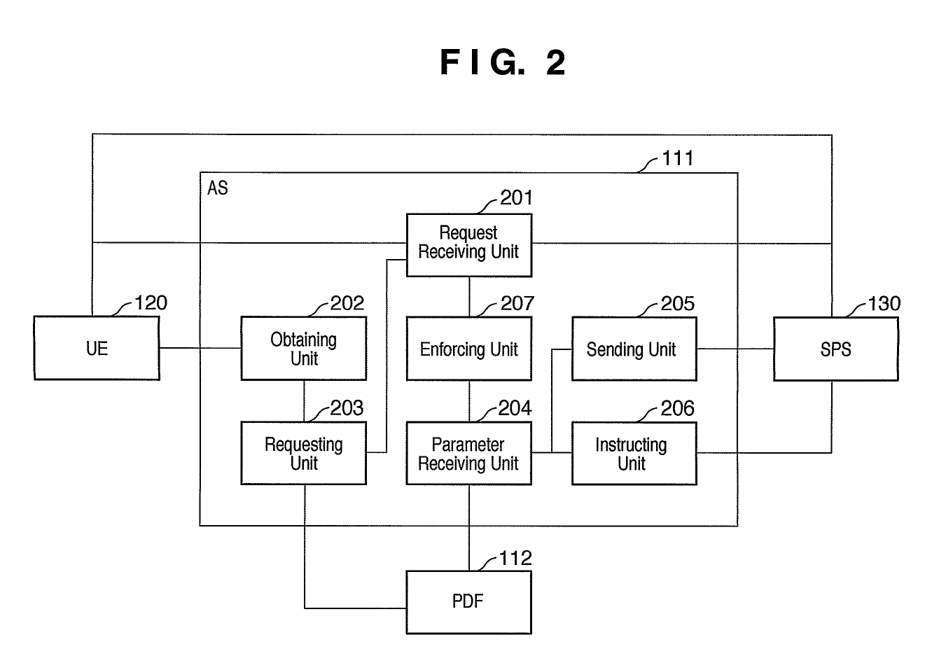

FIG. 2 is a functional block diagram of the AS 111 according to the first embodiment. It should be noted that the functionality of each block in the AS 111 may be implemented using dedicated hardware, using software executed by a processor (not shown) or a combination thereof.

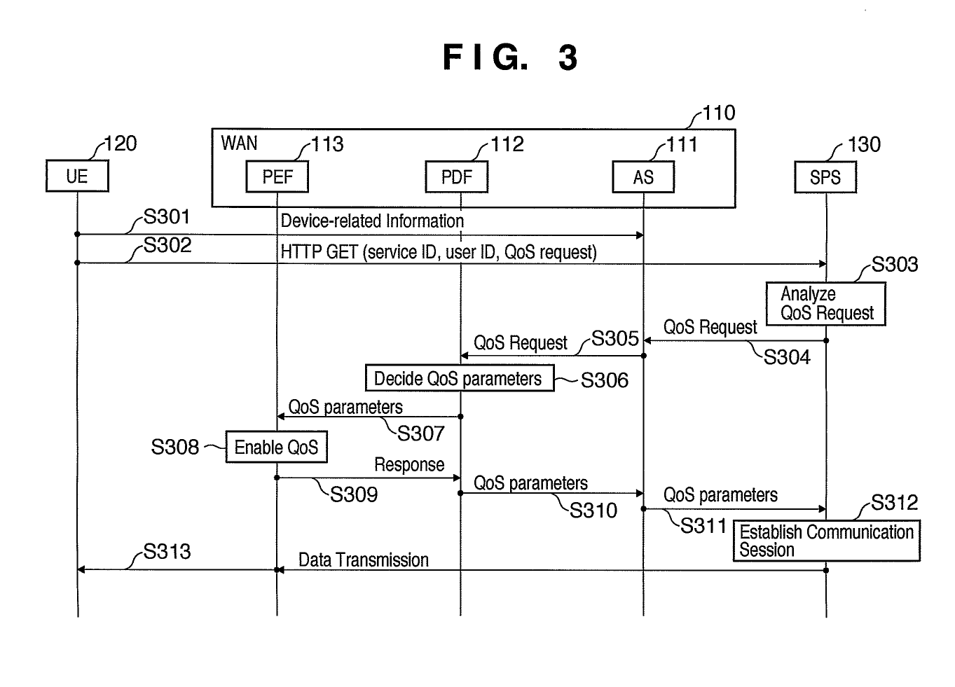

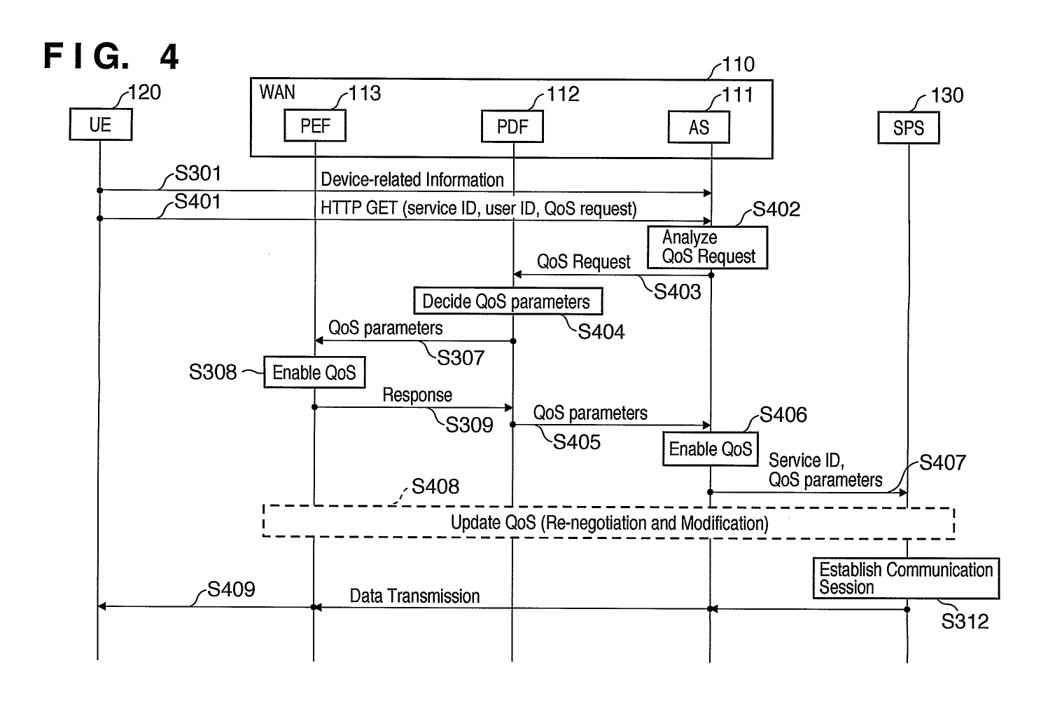

The AS 111 comprises a request receiving unit 201, which receives a QoS request for providing QoS for a communication session between the UE 120 and the SPS 130. The request receiving unit 201 may receive the QoS request from the SPS 130. In some scenarios, the request receiving unit 201 is also configured to act as a proxy server that mediates communication between the UE 120 and the SPS 130. In this case, the request receiving unit 201 receives the QoS request from the UE 120 instead of the SPS 130. The operations of the other blocks in the AS 111 will be described later with reference to the sequence diagrams of FIGS. 3 and 4.

FIG. 3 is a sequence diagram illustrating a procedure for providing QoS for a communication session between the UE 120 and the SPS 130 according to the first embodiment. For the sake of simplicity, operations that are not necessary to describe the present embodiment are omitted in the following sequence diagrams. It should be noted that the present invention is not limited to the protocols described below. For example, the HTTP GET request described below may be replaced by a SIP INVITE message.

In step S301, the UE 120 sends device-related information of the UE 120 to the AS 111 by means of, for example, an HTTP POST request. The device-related information is received by the obtaining unit 202 of the AS 111. The device-related information represents, for example, capability and presence status of the UE 120, and examples of the capability includes the highest bit rate that the UE 120 can handle. The operation of step S301 is periodically performed while the UE 120 is attached to the WAN 110.

In step S302, the UE 120 sends an HTTP GET request to the SPS 130 for establishing a communication session between the UE 120 and the SPS 130. The HTTP GET request may include a service ID, which identifies a service to be received from the SPS 130, a user ID, which identifies a user of the UE 120, and a QoS request for providing QoS for the communication session. The QoS request includes session-related information from which the QoS (e.g., bandwidth, priority, etc.) required for the communication session is derived. It should be noted that the IP packets that send the HTTP GET request include session identification information (e.g., IP addresses and port numbers of the UE 120 and SPS 130, and protocol type to be used) that identifies the communication session.

In step S303, the SPS 130 analyzes the QoS request and determines whether or not the SPS 130 supports the required QoS. If the SPS 130 does not support the required QoS, it modifies the QoS request such that the session-related information indicates the QoS supported by the SPS 130 as the QoS required for the communication session.

In step S304, the SPS 130 sends the QoS request and the session identification information to the AS 111. The QoS request is received by the request receiving unit 201 of the AS 111. The SPS 130 may also send the user ID to the AS 111.

In step S305, the requesting unit 203 of the AS 111 analyzes the QoS request and requests the PDF 112 to decide QoS parameters for enforcing QoS based on the QoS request (in particular, based on the session-related information which indicates the required QoS). In this step, the requesting unit 203 also sends the session identification information to the PDF 112. In addition, the requesting unit 203 may send the device-related information to the PDF 112 and ask the PDF 112 to decide the QoS parameters further based on the device-related information. Moreover, in the case that the request receiving unit 201 has received the user ID in step S304, the requesting unit 203 may retrieve preferences regarding QoS, which are associated with the user ID of the user of the UE 120, send the preferences to the PDF 112, and ask the PDF 112 to decide the QoS parameters further based on the preferences.

In step S306, the PDF 112 decides QoS parameters to be used by the PEF 113 for enforcing the required QoS in the WAN 110. In this step, the PDF 112 may retrieve the current congestion status in the WAN 110 and decide the QoS parameters based on the current congestion status. In the case that the PDF 112 has received the device-related information in step S305, the PDF 112 may decide the QoS parameters such that they do not exceed the capability of the UE 120. Moreover, in the case that the PDF 112 has received the preferences of the user in step S305, the PDF 112 may decide the QoS parameters according to the preferences.

In step S307, the PDF 112 sends the decided QoS parameters and the session identification information to the PEF 113.

In step S308, the PEF 113 enables QoS, using the QoS parameters received in step S307, for the communication session identified by the session identification information.

In step S309, the PEF 113 returns a response to the PDF 112 to notify that QoS was successfully enabled.

In step S310, the PDF 112 sends the QoS parameters decided in step S306 to the AS 111. The QoS parameters are received by the parameter receiving unit 204 of the AS 111.

In step S311, the sending unit 205 of the AS 111 sends a result of the decision of the QoS parameters to the SPS 130. For example the result represents “success” or “failure” of the decision based on the QoS request sent in step S304. Alternatively, the sending unit 205 may sends the decided QoS parameters to the SPS 130 as the result of the decision. In the latter case, if the QoS based on the QoS parameters is lower than a given threshold, the instructing unit 206 of the AS 111 may instruct the SPS 130 to change the protocol of the service identified in step S302 to a less delay-sensitive protocol. For example, assume the case that a video streaming service that uses RTP/UDP/IP packets for real time media transport and a bit rate of 1 Mbps at minimum is requested in step S302, but the available bit rate is only 500 Kbps. In this case, the instructing unit 206 may instruct the SPS 130 to send the video data regarding the requested video streaming service as a single file to the UE 120 by means of, for example, File Transfer Protocol (FTP).

In step S312, the SPS 130 establishes a communication session with the UE 120, and enables QoS for the communication session in the SPS 130 based on the QoS parameters received in step S311.

In step S313, the SPS 130 sends data regarding the service requested in step S302 to the UE 120 via the PEF 113 of the WAN 110. Because the data is relayed by the PEF 113, which has enabled QoS in step S308, the UE 120 can receive the data in a manner whereby the given QoS is ensured.

In an alternative scenario, the AS 111 may act as a proxy server. Specifically, the request receiving unit 201 of the AS 111 acts as a proxy server that mediates the communication between the UE 120 and the SPS 130.

FIG. 4 is a sequence diagram illustrating a procedure for providing QoS for a communication session between the UE 120 and the SPS 130 according to the alternative scenario of the first embodiment. For the sake of simplicity, explanations regarding the use of service IDs, user IDs, preferences, and so on will be omitted, but they can be used in a manner similar to the case of FIG. 3. Moreover, the session identification information is transferred in a manner similar to the case of FIG. 3.

In step S401, the UE 120 sends an HTTP GET request to the request receiving unit 201 of the AS 111 for establishing a communication session between the UE 120 and the SPS 130.

In step S402, the requesting unit 203 of the AS 111 analyzes the QoS request and determines whether or not the AS 111, which acts as the proxy server, supports the required QoS. If the AS 111 does not support the required QoS, the requesting unit 203 modifies the QoS request such that the session-related information indicates the QoS supported by the AS 111 as the QoS required for the communication session.

In step S403, the requesting unit 203 of the AS 111 requests the PDF 112 to decide QoS parameters for enforcing QoS based on the QoS request (in particular, based on the session-related information which indicates the required QoS). In this alternative scenario, the requesting unit 203 may request the PDF 112 to decide QoS parameters to be used by the enforcing unit 207 in addition to QoS parameters to be used by the PEF 113.

In step S404, the PDF 112 decides the QoS parameters to be used by the PEF 113 for enforcing the required QoS in the WAN 110. Moreover, the PDF 112 may decide the QoS parameters to be used by the enforcing unit 207 of the AS 111 for enforcing the required QoS in the request receiving unit 201, which acts as the proxy server. In this step, the PDF 112 may retrieve the current congestion status in the WAN 110 and decide the QoS parameters based on the current congestion status.

In step S405, the PDF 112 sends the QoS parameters for the PEF 113 and the QoS parameters for the enforcing unit 207 decided in step S404 to the AS 111. The QoS parameters are received by the parameter receiving unit 204 of the AS 111.

In step S406, the enforcing unit 207 of the AS 111 enables QoS, using the QoS parameters for the enforcing unit 207 received in step S405, for the communication session in the request receiving unit 201 identified by the session identification information.

In step S407, the sending unit 205 of the AS 111 sends the QoS parameters (both for the PEF 113 and the enforcing unit 207) to the SPS 130. Moreover, the sending unit 205 sends the service ID received in step S401 in order to request the SPS 130 for establishing the communication session between the UE 120 and the SPS 130. In this step, the instructing unit 206 of the AS 111 may instruct the SPS 130 to change the protocol in a manner similar to the case of step S311 of FIG. 3.

In step S408, the SPS 130 may invoke the process of re-negotiating and modifying QoS by sending a QoS updating request to the request receiving unit 201 of the AS 111. This operation is performed in the case that, for example, the SPS 130 cannot satisfy the QoS based on the QoS parameters received in step S407.

In step S409, the SPS 130 sends data regarding the service requested in step S407 to the UE 120 via the request receiving unit 201 of the AS 111 in addition to the PEF 113 of the WAN 110. Because the data is relayed by the request receiving unit 201 and the PEF 113, which have enabled QoS in step S406 and step S308, the UE 120 can receive the data in a manner whereby the given QoS is ensured.

In FIG. 4, it is assumed that the data regarding the service requested by the UE 120 is sent from the SPS 130 to the UE 120 via the AS 111 as described in step S409. However, the SPS 130 may send the data to the UE 120 without going through the AS 111. In this case, enabling QoS in step S406 and the related operation can be omitted.

As described above, because the AS 111 handles the QoS request received from the UE 120 or the SPS 130, QoS control is enabled for communications that are based on a protocol such as HTTP, which does not mandate the use of an SDP message.

### Second Embodiment

The concept of the present invention can also be applied to the case where the UE 120 is included in a network that is different from the WAN 110.

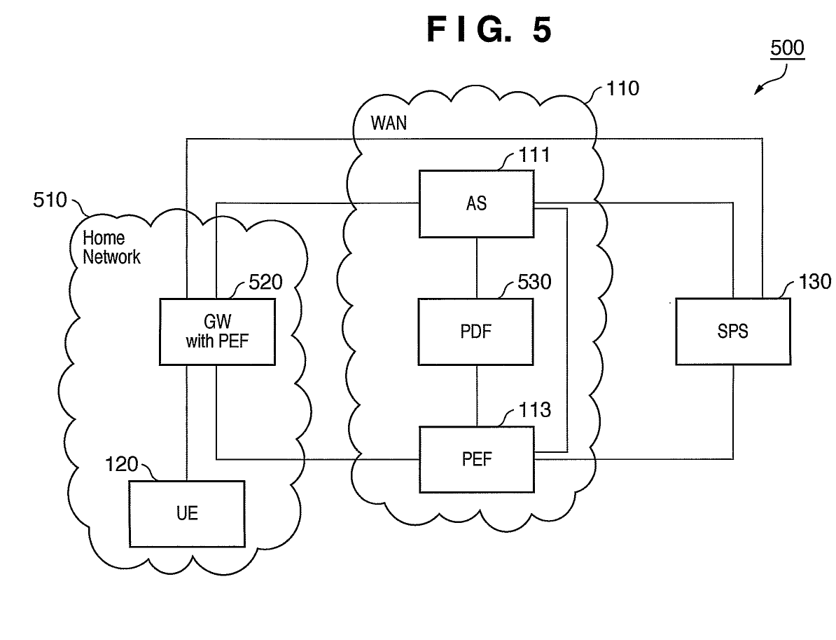

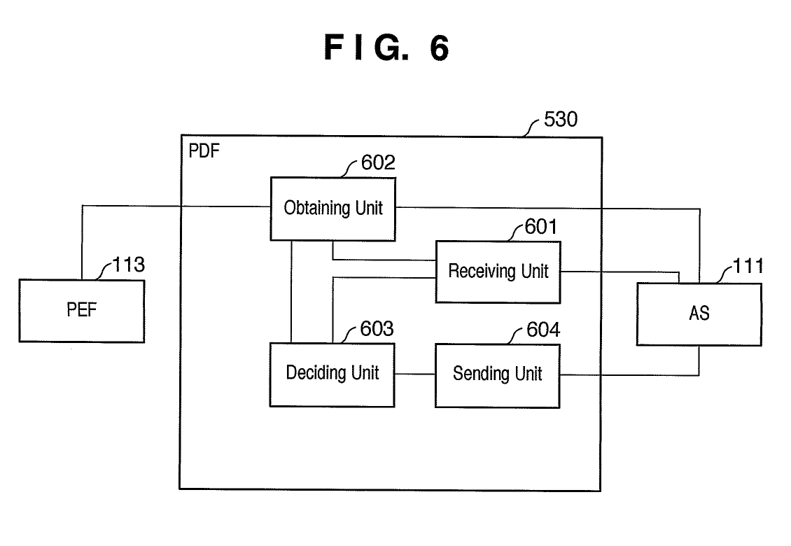

FIG. 5 illustrates an overview of a communication system 500 according to the second embodiment. The communication system 500 includes a home network 510 (also referred to as a first network) and a wide area network (WAN) 110 (also referred to as a second network). The home network 510 is an IP network and is connected to the WAN 110 via a gateway (GW) 520. The GW 520 includes a PEF for enforcing QoS in the home network 510. The WAN 110 may comprise the PDF 112, as is the case for the first embodiment. However, in the case that the WAN 110 comprises a PDF 530 as shown in FIG. 5, which will be described in detail later with reference to FIGS. 6-8, the PDF 530 enables consistent QoS control in the home network 510 and the WAN 110.

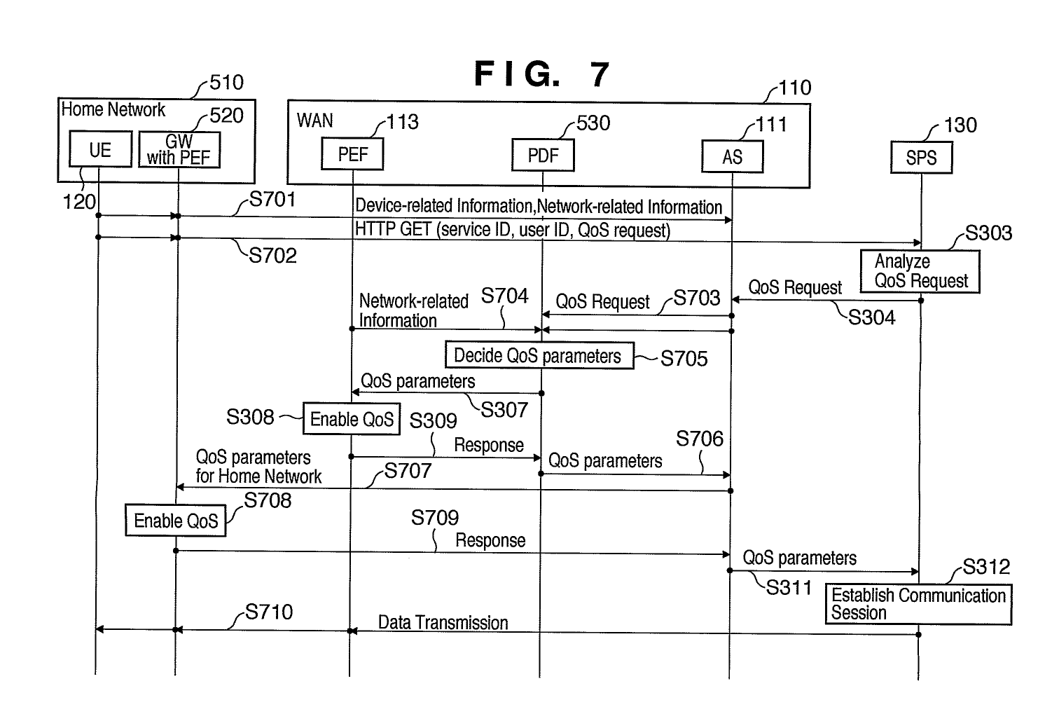

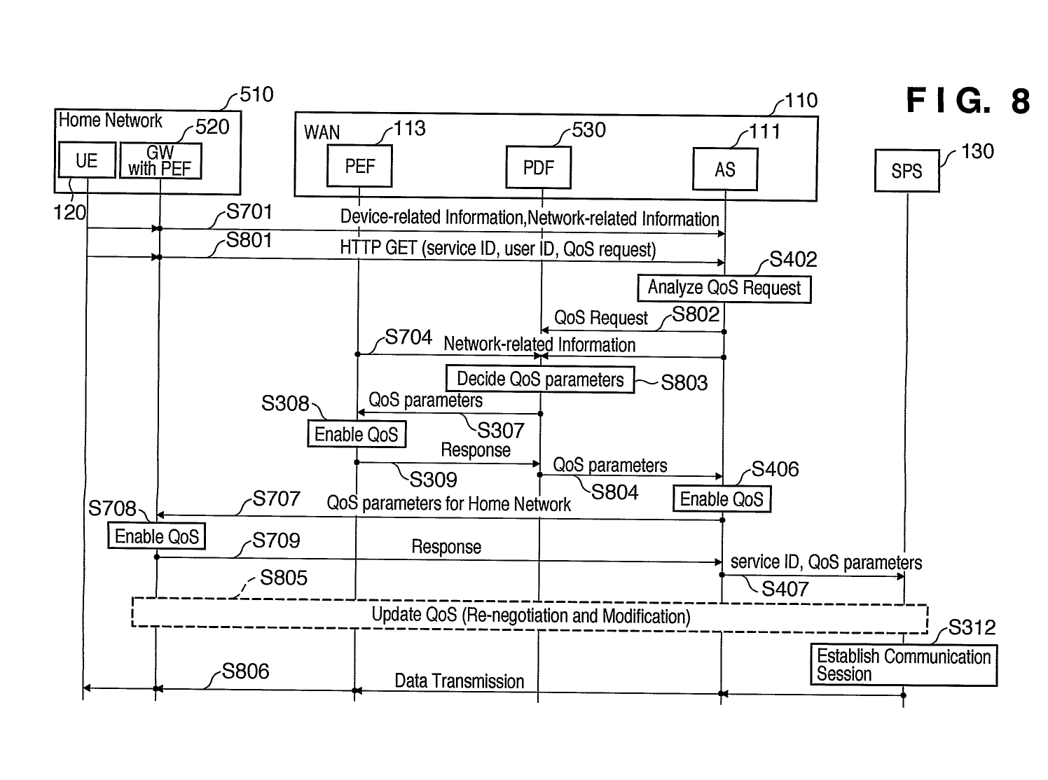

FIG. 6 is a functional block diagram of a policy decision function (PDF) 530 according to the second embodiment. It should be noted that the functionality of each block in the PDF 530 may be implemented using dedicated hardware, using software executed by a processor (not shown) or a combination thereof. The operations of each block in the PDF 530 will be described later with reference to the sequence diagrams of FIGS. 7 and 8.

FIG. 7 is a sequence diagram illustrating a procedure for providing QoS for a communication session between the UE 120 and the SPS 130 according to the second embodiment. For the sake of simplicity, explanations regarding the use of service IDs, user IDs, preferences, and so on will be omitted, but they can be used in a manner similar to the case of FIG. 3. Moreover, the session identification information is transferred in a manner similar to the case of FIG. 3.

In step S701, the GW 520 collects network-related information of the home network 510. The network-related information includes, for example, the number of the on-going sessions and available bandwidth in the home network 510. In other words, the network-related information is information from which highest QoS enforceable for the communication session in the home network 510 can be derived. The GW 520 also collects the device-related information of the UE 120. Then, the GW 520 sends the device-related information and the network-related information to the AS 111 by means of, for example, an HTTP POST request. The operation of step S701 is periodically performed while the GW 520 is attached to the WAN 110.

In step S702, the UE 120 sends an HTTP GET request to the SPS 130 via the GW 520 for establishing a communication session between the UE 120 and the SPS 130.

In step S703, the receiving unit 601 of the PDF 530 receives a request for deciding the QoS parameters for the communication session. The request includes the session-related information.

In step S704, the obtaining unit 602 of the PDF 530 obtains the network-related information of the home network 510 from the AS 111. The obtaining unit 602 also obtains the network-related information of the WAN 110 from the PEF 113. The network-related information of the WAN 110 is, as with the network-related information of the home network 510, information from which the highest QoS enforceable for the communication session in the WAN 110 can be derived.

In step S705, the deciding unit 603 of the PDF 530 decides QoS parameters to be used by the PEF 113 for enforcing the required QoS in the WAN 110. The deciding unit 603 also decides QoS parameters to be used by the PEF of the GW 520 for enforcing the required QoS in the home network 510. In this step, the deciding unit 603 makes the decision of the QoS parameters based on the network-related information of the home network 510 and the network-related information of the WAN 110 in addition to the session-related information which indicates the required QoS, such that the QoS for the home network 510 is consistent (or aligned) with the QoS for the WAN 110. For example, assume a case wherein the session-related information indicates that the communication session requires 5 Mbps at minimum and requires 10 Mbps if possible, the network-related information of the home network 510 indicates that the highest bit rate available in the home network 510 is 10 Mbps, and the network-related information of the WAN 110 indicates that the highest bit rate available in the WAN is 6 Mbps. In this case, the deciding unit 603 decides the QoS parameters for the home network 510 and for the WAN 110 so that 6 Mbps is reserved for the communication session both in the home network 510 and the WAN 110. In this way, wasting of communication resources for a given network can be avoided (as compared with the case where 10 Mbps is reserved for the home network 510 and (10−6) =4 Mbps is wasted therein). In this step, the deciding unit 603 may make a decision of the QoS parameters further based on the device-related information of the UE 120.

In step S706, the sending unit 604 of the PDF 530 sends the QoS parameters for the WAN 110 to the AS 111. The sending unit 604 also sends the QoS parameters for the home network 510 and the session identification information to the AS 111.

In step S707, the AS 111 sends the QoS parameters for the home network 510 and the session identification information to the GW 520. Alternatively, the sending unit 604 may send the QoS parameters for the home network 510 and the session identification information directly to the GW 520 in step S706.

In step S708, the PEF of the GW 520 enables QoS, using the QoS parameters received in step S708, for the communication session identified by the session identification information.

In step S709, the GW 520 returns a response to the AS 111 to notify that QoS was successfully enabled in the home network 510.

In step S710, the SPS 130 sends data regarding the service requested in step S702 to the UE 120 via the PEF 113 of the WAN 110 and the GW 520. Because the data is relayed by the PEF 113 and the GW 520, which have enabled QoS in step S308 and step S708, the UE 120 can receive the data in a manner whereby the given QoS is ensured.

In an alternative scenario, the AS 111 may act as a proxy server. Specifically, the request receiving unit 201 of the AS 111 acts as a proxy server that mediates communication between the UE 120 and the SPS 130.

FIG. 8 is a sequence diagram illustrating a procedure for providing QoS for a communication session between the UE 120 and the SPS 130 according to the alternative scenario of the second embodiment. For the sake of simplicity, explanations regarding the use of service IDs, user IDs, preferences, and so on will be omitted, but they can be used in a manner similar to the case of FIG. 3. Moreover, the session identification information is transferred in a manner similar to the case of FIG. 3.

In step S801, the UE 120 sends an HTTP GET request to the request receiving unit 201 of the AS 111 via the GW 520 for establishing a communication session between the UE 120 and the SPS 130.

In step S802, the requesting unit 203 of the AS 111 requests the PDF 530 to decide QoS parameters for enforcing QoS based on the QoS request (in particular, based on the session-related information which indicates the required QoS). In this alternative scenario, the requesting unit 203 may request the PDF 530 to decide QoS parameters to be used by the enforcing unit 207 in addition to QoS parameters to be used by the PEF 113. The QoS request is received by the receiving unit 601 of the PDF 530.

In step S803, the deciding unit 603 of the PDF 530 decides the QoS parameters to be used by the PEF 113 for enforcing the required QoS in the WAN 110. The deciding unit 603 also decides the QoS parameters to be used by the PEF of the GW 520 for enforcing the required QoS in the home network 510. Moreover, the PDF 112 may decide the QoS parameters to be used by the enforcing unit 207 of the AS 111 for enforcing the required QoS in the request receiving unit 201, which acts as the proxy server. In this step, the deciding unit 603 makes the decision such that the QoS parameters for the home network 510, the QoS parameters for the PEF 113, and the QoS parameter for the enforcing unit 207 of the AS 111 are consistent with each other in order to avoid a waste of communication resources.

In step S804, the sending unit 604 of the PDF 530 sends the QoS parameters for the home network 510, the QoS parameters for the PEF 113, and the QoS parameters for the enforcing unit 207 decided in step S803 to the AS 111.

In step S805, the SPS 130 may invoke the process of re-negotiating and modifying QoS by sending a QoS updating request to the request receiving unit 201 of the AS 111. This operation is performed in the case that, for example, the SPS 130 cannot satisfy the QoS based on the QoS parameters received in step S407.

In step S806, the SPS 130 sends data regarding the service requested in step S407 to the UE 120 via the request receiving unit 201 of the AS 111 in addition to the PEF 113 of the WAN 110 and the GW 520. Because the data is relayed by the request receiving unit 201, the PEF 113, and the GW 520 which have enabled QoS in step S406, step S308, and step S708, the UE 120 can receive the data in a manner whereby the given QoS is ensured.

In FIG. 8, it is assumed that the data regarding the service requested by the UE 120 is sent from the SPS 130 to the UE 120 via the AS 111 as described in step S409. However, the SPS 130 may send the data to the UE 120 without going through the AS 111. In this case, enabling QoS in step S406 and the related operation can be omitted.

As described above, because the AS 111 handles the QoS request received from the UE 120 or the SPS 130, QoS control is enabled for communications based on a protocol such as HTTP, which does not mandate the use of an SDP message.

Moreover, because the PDF 530 decides the QoS parameters for the home network 510 and the WAN 110 in a centralized manner, consistent QoS control may be enabled in a plurality of networks.

(Variations)

As shown in FIG. 7, the AS 111 has the function of collecting the network-related information of the home network 510. However, this function can be separated from the AS 111. In this case, the PDF 530 may obtain the network-related information of the home network 510 from, for example, a presence server managing the home network 510.

The concept of the present invention can be applied to cases where the UE 120 sends and receives the application level session control messages without using the GW 520 as a proxy. In this case, the QoS parameters for the home network 510 can be transferred from the PDF 530 to the UE 120 without going through the GW 520.

The concept of the present invention can be applied to cases where the request for establishing the communication session between the UE 120 and the SPS 130 is initiated by a third party device. However, it is not necessary for the third party device to be included in the home network 510.

The AS 111 can provide the PDF 530 with the address information of the GW 520 so that the PDF 530 can send the QoS parameters for the home network 510 to the GW 520 directly (i.e., without going through the AS 111.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1.-23. (canceled)

24. A control node for use in a network that includes a decision node for deciding a quality of service (QoS) parameter, a first communication device connected to the network, and a second communication device connected to the network, the control node comprising:
a request receiving unit configured to receive a QoS request for providing QoS for a communication session between the first and second communication devices, the QoS request including session-related information from which QoS required for the communication session is derived;
a requesting unit configured to request the decision node to determine a QoS parameter for enforcing QoS for the communication session based on the session-related information;
a parameter receiving unit configured to receive the QoS parameter determined by the decision node;
a sending unit for sending a QoS decision result based on the QoS parameter to the second communication device.

25. The control node of claim 24 wherein:
the request receiving unit is further configured to receive, from the first communication device, the QoS request and a session request for establishing the communication session;
the sending unit is configured to:
send the QoS parameter to the second communication device as the QoS decision result;
forward the session request to the second communication device.

26. The control node of claim 25 wherein:
the parameter receiving unit further configured to receive a QoS parameter for the control node decided by the decision node;
the control node further comprises an enforcing unit configured to enforce QoS for the communication session in the control node based on the QoS parameter for the control node.

27. The control node of claim 25 wherein:
the request receiving unit is further configured to receive, from the second communication device, a QoS updating request for updating the QoS for the communication session.

28. The control node of claim 24 further comprising:
an obtaining unit configured to obtain, from the first communication device, device-related information which represents capability of the first communication device;
wherein the requesting unit is configured to request the decision node to determine the QoS parameter based on the device-related information.

29. The control node of claim 24 further comprising:
an instructing unit configured to instruct the second communication device to change a protocol used for data transfer in the communication session to a less delay-sensitive protocol in response to QoS based on the QoS parameter being lower than a predetermined threshold.

30. The control node of claim 24 wherein:
the request receiving unit further configured to receive identification information which is associated with a preference of a user of the first communication device regarding QoS;
the requesting unit is further configured to request the decision node to determine the QoS parameter based on the preference.

31. A control node for use with a first network connected to a second network via a gateway node, the first network including a first communication device, the second network including a second communication device and a decision node for determining a quality of service (QoS) parameter, the control node comprising:
a request receiving unit configured to receive a QoS request for providing QoS for a communication session between the first communication device and the second communication device, the QoS request including session-related information from which QoS required for the communication session is derived;
a requesting unit configured to request the decision node to determine a QoS parameter for enforcing QoS for the communication session based on the session-related information;
a parameter receiving unit configured to receive a second QoS parameter for the second network, determined by the decision node, for enforcing QoS for the communication session in the second network;
a sending unit configured to send a QoS decision result based on the second QoS parameter to the second communication device.

32. The control node of claim 31 wherein:
the request receiving is configured to receive the QoS request and receive a session request for establishing the communication session from the first communication device via the gateway node;
the sending unit is configured to:
send the second QoS parameter to the second communication device;
forward the session request to the second communication device.

33. The control node of claim 32 wherein:
the parameter receiving unit is further configured to receive a third QoS parameter for the control node determined by the decision node, for enforcing QoS for the communication session in the control node;
the control node further comprises an enforcing unit for enforcing QoS for the communication session in the control node based on the third QoS parameter.

34. The control node of claim 32 wherein:
the request receiving unit is further configured to receive, from the second communication device, a QoS updating request for updating the QoS for the communication session.

35. The control node of claim 31 further comprising:
an obtaining unit configured to obtain, from the gateway node, first network-related information from which highest QoS enforceable for the communication session in the first network is derived;
wherein the requesting unit is configured to request the decision node to determine the QoS parameter based on the first network-related information;
wherein the parameter receiving unit is further configured to receive a first QoS parameter for the first network determined by the decision unit, for enforcing QoS for the communication session in the first network;
the sending unit is further configured to send the first QoS parameter to the gateway node.

36. The control node of claim 35 wherein:
the obtaining unit is further configured to obtain, from the gateway node, device-related information which represents capability of the first communication device;
the requesting unit is configured to request the decision node to determine the QoS parameter based on the device-related information.

37. The control node of claim 31 further comprising:
an instructing unit configured to instruct the second communication device to change a protocol used for data transfer in the communication session to a less delay-sensitive protocol in response to QoS based on the second QoS parameter is lower than a predetermined threshold.

38. The control node of claim 31 wherein:
the request receiving unit is further configured to receive identification information which is associated with a preference of a user of the first communication device regarding QoS;
the requesting unit is configured to request the decision node to determine the QoS parameter based on the preference.

39. A decision node for determining a quality of service (QoS) parameter in an environment where a first network is connected to a second network via a gateway node, the first network includes a first communication device and a first QoS enforcement node for enforcing QoS in the first network, the second network includes a second QoS enforcement node for enforcing QoS in the second network and a second communication device, the decision node comprising:
a receiving unit configured to receive a request for determining a QoS parameter for a communication session between the first communication device and the second communication device, the request including session-related information from which QoS required for the communication session is derived;
an obtaining unit configured to:
obtain, from a control node which communicates with the gateway node, first network-related information from which highest QoS enforceable for the communication session in the first network is derived;
obtain, from the second QoS enforcement node, second network-related information from which highest QoS enforceable for the communication session in the second network is derived;
a deciding unit configured to determine a first QoS parameter for enforcing QoS for the communication session in the first network and a second QoS parameter for enforcing QoS for the communication session in the second network based on the session-related information, the first network-related information, and the second network-related information;
a sending unit configured to:
send the first QoS parameter to the first QoS enforcement node;
send the second QoS parameter to the second QoS enforcement node.

40. The decision node of claim 39 wherein the sending unit is configured to send the first QoS parameter to the first QoS enforcement node via the control node.

41. The decision node of claim 39 wherein the receiving unit is configured to receive the request from the control node.

42. The decision node of claim 39 wherein:
the obtaining unit is further configured to obtain, from the control node, device-related information which represents capability of the first communication device;
the deciding unit is configured to determine the first QoS parameter and the second QoS parameter based on the device-related information.

43. The decision node of claim 39 wherein:
the receiving unit is further configured to receive a preference of a user of the first communication device regarding QoS;
the deciding unit is further configured to determine the first QoS parameter and the second QoS parameter based on the preference.

44. A method for controlling a control node in a network that includes a decision node for deciding a quality of service (QoS) parameter, a first communication device connected to the network, and a second communication device connected to the network, the method comprising:
receiving a QoS request for providing QoS for a communication session between the first communication device and the second communication device, the QoS request including session-related information from which QoS required for the communication session is derived;
requesting the decision node to decide a QoS parameter for enforcing QoS for the communication session based on the session-related information;
receiving a QoS parameter for the network, determined by the decision node, for enforcing QoS for the communication session in the network;
sending the QoS parameter for the network to the second communication device.

45. A method for controlling a control node for use with a first network connected to a second network via a gateway node, the first network including a first communication device, the second network including a second communication device and a decision node for determining a quality of service (QoS) parameter, the method comprising:
receiving a QoS request for providing QoS for a communication session between the first communication device and the second communication device, the QoS request including session-related information from which QoS required for the communication session is derived;
requesting the decision node to determine a QoS parameter for enforcing QoS for the communication session based on the session-related information;
receiving a QoS parameter for the second network, determined by the decision node, for enforcing QoS for the communication session in the second network;
sending the QoS parameter for the second network to the second communication device.

46. A method for controlling a decision node for deciding a quality of service (QoS) parameter in an environment where a first network is connected to a second network via a gateway node, the first network including a first communication device and a first QoS enforcement node for enforcing QoS in the first network, the second network including a second communication device and a second QoS enforcement node for enforcing QoS in the second network, comprising:
receiving a request for deciding a QoS parameter for a communication session between the first communication device and the second communication device, the request including session-related information from which QoS required for the communication session is derived;
obtaining, from a control node which communicates with the gateway node, first network-related information from which highest QoS enforceable for the communication session in the first network is derived;
obtaining, from the second QoS enforcement node, second network-related information from which highest QoS enforceable for the communication session in the second network is derived;
determining a first QoS parameter for enforcing QoS for the communication session in the first network and a second QoS parameter for enforcing QoS for the communication session in the second network based on the session-related information, the first network-related information, and the second network-related information;
sending the first QoS parameter to the first QoS enforcement node;
sending the second QoS parameter to the second QoS enforcement node.
